(19) United States
(12) Patent Application Publication
(10) Pub. No.: US 2005/0055687 A1
(43) Pub. Date: Mar. 10, 2005

(54) Software update information via session initiation protocol event packages

(76) Inventor: Georg Mayer, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/656,862

(22) Filed: Sep. 4, 2003

(51) Int. Cl. G06F 9/44

(52) U.S. Cl. 717/173

(57) ABSTRACT

A method and system of finding out about and downloading software updates to a terminal, in which the terminal sends a standardized subscribe request for software updates, and a server responds by sending an initial notify message back to the sending terminal only, the initial notify message having content defined by an event package. This system and method utilize an application layer protocol called Session Initiation Protocol, and the event package requires information as to software name, update server address, update retrieval protocol, and latest version. The terminal checks if it has the available software version, and if not then the terminal automatically downloads the update, or the user is given a choice whether to download and obtain the available software version. The terminal and other terminals subsequently receive a further type of notify message having content again defined by the event package, describing at least one newly available update.

### TECHNICAL FIELD OF THE INVENTION

The invention relates to software updates, and more particularly procedures for finding out about and downloading software updates.

### BACKGROUND ART

Session Initiation Protocol (SIP) is an application layer protocol, at layer seven of the Open Systems Interconnection (OSI), which is an internationally accepted framework of standards for communication between different systems made by different vendors. SIP is for the establishment, modification, and termination of conferencing and telephony sessions over an internet protocol (IP) network. SIP is further defined by the Internet Engineering Task Force (IETF), in Request for Comments (RFC) 3261. As thus defined, SIP allows for the establishment, handling and release of end-to-end multimedia sessions.

There have been several additions to the SIP protocol, which for example allow event notification based on SIP, which is the basis for an SIP-based Presence Service and other services. One of these Extensions is the SIP events framework, which is specified in RFC 3265. The SIP events framework allows a user to subscribe to certain type of information (so-called “events”) from a notifier. The information to be reported by a notifier to a subscriber is defined by an event package, and the notifier then sends notifications to the subscriber when the information changes. The SIP events framework leaves the definition of SIP events to the event packages, which are concrete extensions of the SIP events framework.

Event packages extend or modify basic event package behavior. However, event packages will not succeed if they weaken certain core aspects of basic behavior, even though such aspects can be strengthened or supplemented. There is a set of specific issues that must be addressed by the inventor of an event package, and this has been achieved by various concrete “event package” extensions of the general SIP events framework. These prior art event packages have made use of SIP's “SUBSCRIBE” and “NOTIFY” functions, while addressing the specific issues that must be addressed by an event package inventor. See, for example, “A Presence Event Package for the Session Initiation Protocol (SIP) by J. Rosenberg (IETF Internet Draft). Nevertheless, an SIP event package for software updates has not heretofore been accomplished.

As software updates for installations running on personal computers or wireless terminals become more frequent, easier methods for accomplishing these updates are needed. To make the update to the new software version easier to use, applications nowadays often implement proprietary mechanisms to get informed about an updated version. The user then gets informed about the possible update and may request that the new version be automatically installed. These propriety mechanisms are not consistent with each other, nor do they utilize the functionality made available by the SIP events framework. The user has to cope with a multitude of different procedures for the different applications used at the user's terminal. A need exists for applications to become aware of newer software versions as they become available, using the SIP events framework.

### DISCLOSURE OF THE INVENTION

In the near future, every wireless terminal and most likely every personal computer (PC) too will provide a generic SIP stack, which can be used by any kind of application. A protocol stack is basically a collection of modules of software that together combine to produce the software that enables the protocol to work, i.e. to allow communications between dissimilar computer devices. It is called a “stack” because the software modules are piled on top of each other, and the process of communicating typically starts at the bottom of the stack and works up the stack.

The basic SIP functionality is now proposed to be extended in a new way, so that software applications can subscribe to an event which will cause a notification whenever a new version of the software is available. A new SIP Event Package is defined, for example called “software-update.” The update will include notification, for example in extensible markup language (XML), about items such as the size of the new software-version, its version-number, a link to the download-site, the price of the update if any, et cetera.

The software application, when started on the user terminal, initiates a procedure for the SIP stack to send a SUBSCRIBE message with the “software-update” event in the event header of the SUBSCRIBE message. Within the body of the SUBSCRIBE message from the user terminal, more detailed information about the application is given, in order to specify the software which the subscriber is interested in (e.g. “Wireless Presenter” software).

This SUBSCRIBE message is sent to a server, which can either be a server of the software provider or a centralized software server in the network. If the server has information about the indicated application available, it sends to the user terminal a 200 OK, which indicates that the request has succeeded, and immediately a NOTIFY message, indicating the current version of the software that could be downloaded. The application in the terminal checks if an update is needed or not. If an update is needed it may either automatically download and install the software, or ask the user.

When a new update for the software is available, the software-server will send out a new NOTIFY to all subscribers. The application in the terminal, when receiving this NOTIFY, checks if an update is needed or not. If an update is needed it may either automatically download and install the software, or ask the user. The update can then be downloaded via the network.

This standardized mechanism is implemented via an SIP application programming interface (API), using centralized software-servers with a generic (SIP) interface. This allows updates of different applications to be announced in a generic way.

The present invention provides a generic mechanism that works for every application, in order for a user to get informed about software updates. This mechanism will, for example, work for every software that is running on a machine which also involves an SIP Stack.

The method and system of the present invention are for helping a terminal to find out about and download software updates, in which the terminal sends a standardized subscribe request for software updates. A server responds by sending an initial notify message back to the sending terminal only, the initial notify message having content defined by an event package. This system and method utilize an application layer protocol called Session Initiation Protocol, and the event package requires information as to software name, update server address, update retrieval protocol, and latest version. The terminal checks if it has the available software version, and if not then the terminal automatically downloads the update, or the user is given a choice whether to download and obtain the available software version. The terminal and other terminals subsequently receive a further type of notify message having content again defined by the event package, describing at least one newly available update. The invention also includes a computer-readable medium encoded with a data structure for performing the method just described.

The system includes a first user terminal for sending a standardized subscribe request signal indicative of at least one application in the first user terminal. A software server, responsive to the standardized subscribe request signal, is for providing an initial notify signal having content defined by an event package, the initial notify signal being indicative of at least one available software version. The system further comprises other user terminals that have at least one application in common with the first terminal. The first user terminal and the other user terminals are responsive to a further type of notify signal having content defined by the event package, the further type of notify signal being indicative of at least one newly available update to the at least one application in common. The first user terminal and the other user terminals are for downloading the at least one newly available update insofar as respective users approve the downloading, or insofar as the respective users have approved automatic downloading.

The invention further includes a subscriber user terminal for finding out about and downloading software updates, the subscriber terminal including a plurality of application modules for providing a respective application profile including a respective software version. The subscriber user terminal also includes a software update module, for subscribing to at least one server in order to receive software update notifications regarding the plurality of application modules. The software update module is responsive to each of the notifications, by requesting at least one of the respective application profiles from the application modules, performing a comparison with a respective one of the notifications, and initiating a download procedure if the comparison indicates a mismatch. The user may have an option to stop the download procedure, for example, if the price of the download is too high.

### BRIEF DESCRIPTION OF THE DRAWINGS

FIG. 1 depicts the method according to one of the preferred embodiments of the present invention.

FIG. 2 shows the system of the present invention according to one of the preferred embodiments, including a subscriber user terminal and other components.

### BEST MODE FOR CARRYING OUT THE INVENTION

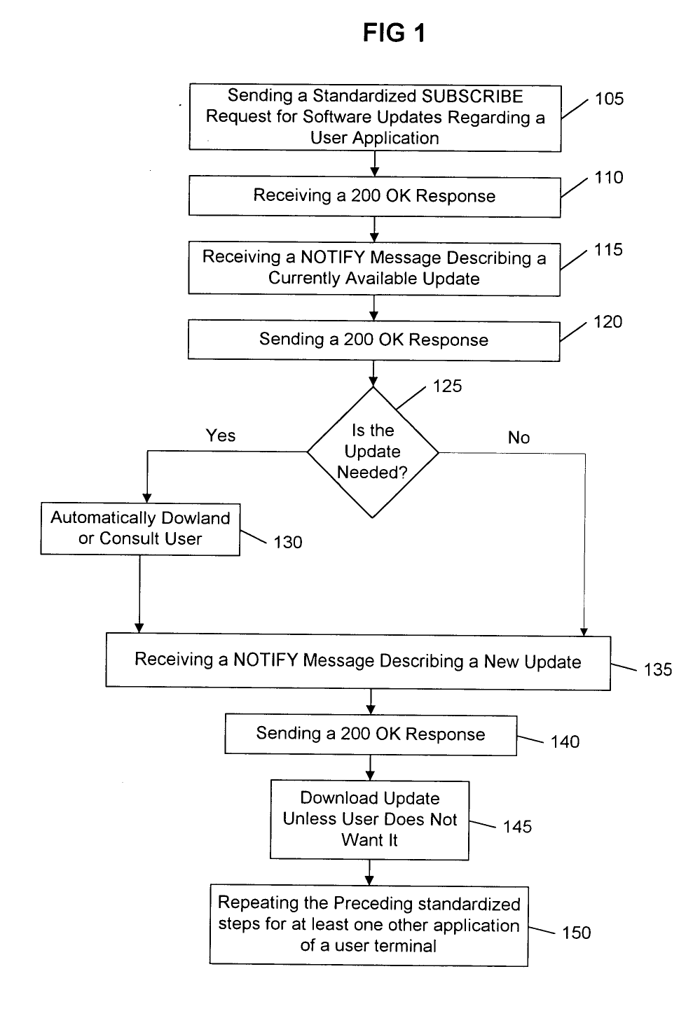

A best mode embodiment will now be discussed in order to demonstrate in detail how a person skilled in the art is enabled to practice the present invention, so that a user terminal will find out about and download software updates. This embodiment utilizes and is formatted based upon an application layer protocol known as Session Initiation Protocol (SIP). As seen in the flow chart of FIG. 1, a preferred method 100 according to the present invention begins by sending 105 a standardized subscribe request for software updates regarding an application of a user terminal. For example, this SUBSCRIBE request has the following format:

SUBSCRIBE software-update-server.homel.net

Event: software-update
Expires: 6000
Contact: 1.2.3.4

Then a 200 OK Response is received 110, followed by an initial NOTIFY message 115 having content defined by an event package, the initial notify message describing at least one available software version. For example, the NOTIFY message has the following format:

NOTIFY 1.2.3.4

Event: software-update

<software>
<name>SW1</name>
<latest-version>1 </latest-version>
<update-server-address>a.b.c.d</update-server-address>
<update-retrieval-protocol>HTTP</upate-retrieval-protocl>
</software>
<software>
<name>SW2</name>
<latest-version>23</latest-version>
<update-server-address>1.f.2.f</update-server-address>
<update-retrieval-protocol>FTP</upate-retrieval-protocl>
</software>

The event package requires at least one set of information as to software name (e.g. SW1 and SW2), update server address, update retrieval protocol, and latest version. The information may further include things like an update price and a latest update date. The initial NOTIFY message is acknowledged by sending a 200 OK Response 120.

The next step is checking 125 if the user terminal has the available software version, and if not then 130 automatically downloading an update to obtain the available software version, or giving the user a choice whether to download and obtain the available software version.

The next step is receiving 135 a further type of notify message having content defined by the same event package, the further type of notify message describing at least one newly available update. For example, this new NOTIFY message has the following format:

NOTIFY 1.2.3.4

Event: software-update

<software>
<name>SW1</name>
<latest-version>2</latest-version>
<update-server-address>a.b.c.d</update-server-address>
<update-retrieval-protocol>HTTP</upate-retrieval-protocl>
</software>
<software>
<name>SW2</name>
<latest-version>23</latest-version>
<update-server-address>1.f.2.f</update-server-address>
<update-retrieval-protoco1>FTP</upate-retrieval-protoc1>
</software>

This new NOTIFY message is acknowledged 140 by a 200 Okay. The next step is to download 145 the newly available update unless the user gets and exercises an option to not receive the newly available update. The user may have already programmed the terminal so that the downloading is entirely automatic, in which case the user does not get such an option, but the user may have programmed the terminal so that the user does get an option to refuse the download. Whether or not the user gets such an option may depend upon the price of the download, and also may depend upon which application in the terminal the downloaded software update is for. In the example given above, the download is accomplished when the terminal (also called a user equipment or UE) establishes a hypertext transfer protocol (HTTP) session with a.b.c.d and downloads the update for version 2 of SW1 via HTTP. The version 23 update of SW2 will not be downloaded, because that version has not changed since the initial NOTIFY.

SW1 version 1 and SW2 version 23 were both available to subscribers prior to the standardized subscribe request 105, but the newly available update version 2 of SW1 is newly available to subscribers when the further type of notify message is received 135. SW1 and SW2 are, of course, software for two different applications in the UE. Not every NOTIFY message need cover every application in the UE, or even every application in the UE for which software updates are needed, and instead NOTIFY messages can be received by the UE that cover only software for which new updates are available. Although all software in which the user is interested can be requested in a single SUBSCRIBE message, it is also appropriate to send separate SUBSCRIBE messages, in which case the method 100 is simply repeated 150.

The further type of notify message is received 135 substantially simultaneously by the user terminal and other user terminals, but the initial notify message is received 115 only by the user terminal at a time that is substantially immediately after the standardized subscribe request is sent 105 and acknowledged 110.

The subscribe request is sent 105 either to a centralized software server in the network, or to a respective server of a software provider. In order to execute the present method 100, the UE is provided with a computer-readable medium or media encoded with a data structure for performing the method, and this software itself may be among the software that is updated by the present method.

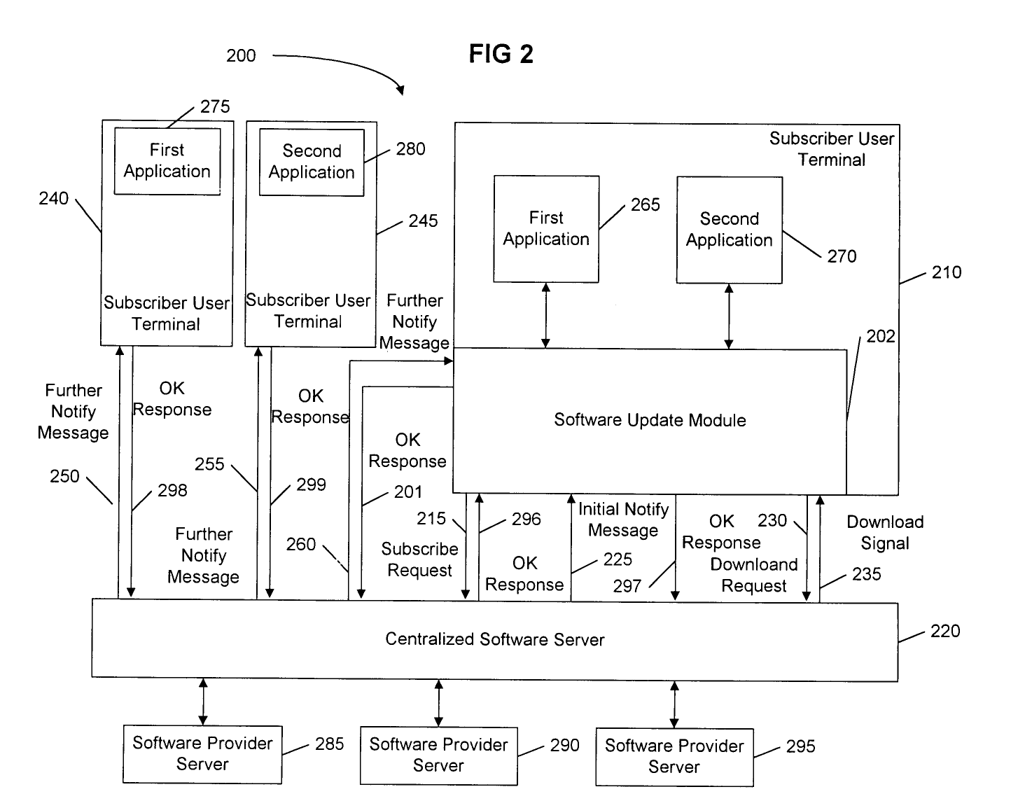

FIG. 2 shows a system 200 for finding out about and downloading software updates. The system includes a first user terminal 210, for sending a standardized subscribe request signal 215 indicative of at least one application in the first user terminal. The system also includes a software server 220, responsive to the standardized subscribe request signal 215, for providing an initial notify signal 225 having content defined by an event package, the initial notify signal being indicative of at least one available software version.

The first user terminal 210 is also for requesting 230 and receiving 235 a downloaded update so as to obtain an available software version, if the first terminal 210 lacks that software version, provided that a user of the first terminal approved the downloading or has approved automatic downloading. In other words, the user can give a case-by-case approval or instead can give a blanket approval for downloads of software updates.

The system 200 further comprises other user terminals 240, 245 that have at least one application in common with the first terminal. The first user terminal 210 and the other user terminals 240, 245 are responsive to a further type of notify signal 250, 255, and 260 having content defined by the event package, and indicative of at least one newly available update to a common application. The first user terminal 210 and the other user terminals 240, 245 are for downloading the at least one newly available update insofar as respective users approve the downloading, or insofar as the respective users have approved automatic downloading.

The first application 265 and the second application 270 in the user terminal 210 match the first application 275 and the second application 280 in the other user terminals 240, 245. These two application include applications from two different software providers. It is then advantageous for the software server 220 to be a centralized software server, which communicates with separate software provider servers 285, 290, 295. However, it should be borne in mind that the first user terminal 210 and the other user terminals 240, 245 can instead communicate directly with the separate software provider servers 285, 290, 295 if there is no centralized software server 220. Of course, the various signals 215, 225, 250, 255, and 260 are acknowledged by respective 200 OK signals 296, 297, 298, 299, 201.

The first user terminal 210 may also be called a subscriber user terminal. It includes a software update module 202, for sending, receiving and processing the aforementioned signals to and from the first user terminal 210, in order to receive software update notifications regarding the application modules 265 and 270.

The software update module 202 is for responding to each of the notifications 225, 260 by obtaining application profiles from or about the application modules, performing a comparison with a respective one of the notifications, and initiating a download procedure if the comparison indicates a mismatch.

According to Section 4.4 of RFC 3265, authors and inventors of event packages can address various details, when applicable:
A. Event Package Name
B. NOTIFY bodies
C. Event Package Parameters
D. SUBSCRIBE bodies
E. Subscription Duration
F. Notifier processing of SUBSCRIBE requests
G. Notifier generation of NOTIFY requests
H. Subscriber processing of NOTIFY requests
I. Handling of forked requests
J. Rate of notifications
K. State Agents
L. Examples
M. Use of URIs to Retrieve State

Different embodiments of the present invention will handle these details somewhat differently, and therefore it is understood that this discussion involves only an example. Regarding the event package name (A), there are various possibilities that will be obvious to those skilled in the art, for example “software-update.” Concerning NOTIFY bodies (B) and package parameters (C), the package parameters may advantageously include Software-Name, Update-Server-Address, Update-Retrieval-Protocol (e.g. HTTP, FTP, et cetera), Latest-Version, and Latest-Update-Date/-Time. With respect to SUBSCRIBE bodies (D), those include a list of programs/software for which update information is requested; otherwise the SUBSCRIBE bodies are generally assumed to be empty.

Regarding subscription duration (E), there will be either fetching, wherein the client occasionally asks the server, in which case the duration would be null (zero), or alternatively there will be a more permanent duration. In the case of the more permanent duration, the duration would occur while the machine on which the software is installed is running, or while the program itself is running, or while the SIP Stack is running.

Concerning Notifier processing of SUBSCRIBE requests (F), a NOTIFY is sent back, including the current data for the related software. That related software is all software that the notifier has information about if no SUBSCRIBE body is given, or only that software that is indicated in the SUBSCRIBE body. With respect to Notifier generation of NOTIFY requests (G), a state is held for every subscription with a zero expiration time, and the subscribe is informed with another NOTIFY whenever the version of software has changed, similar to the Notifier processing (F).

Regarding Subscriber processing of NOTIFY requests (H), it is checked whether the version number/last-update time/date of software that is running on the machine is higher than the currently installed version. If yes, then the user is informed. If the user wants to download, then the information from the NOTIFY is used to start download and possible auto-install.

Handling of forked requests (I), State Agents (K), and use of URIs to Retrieve State (M) are not applicable to the present type of event package. The Rate of notifications (J) should not be a problem, as the present type of event will occur relatively seldom. The examples (L) have already been discussed, with respect to FIG. 1 and FIG. 2.

The present invention is directed at providing software update notifications, but can be extended to provide notifications when new replacement software becomes available, wherein the replacement software has similar functionality or purpose but a different software provider from the software that it would replace. For example, a user who has a software program might be interested in finding out if a competing software product becomes available that is better or cheaper, so that the user will perhaps switch over to the new product instead of continuing to update the old product. Then it is no longer dedicated software that the user wants information about, but rather a type of application. This type of situation is more complicated for the client (i.e. user) to handle; for example the client must decide if the alternative software installation will cause the original software to be deleted. Nevertheless, such an extension of the present invention is doable, and potentially useful.

According to a best mode of the present invention, the user terminal will send a SUBSCRIBE message each time the software application is used by the user, or alternatively only the first time. Further alternatives are possible without departing from the scheme of the invention. It is noted that, although the 200 okay messages discussed herein might seem redundant, every SIP request (besides ACK) must be acknowledged by a final response quite apart from the present invention, and there is no way around that.

At the instant when a new update for the software is available, a software-server will send out a new NOTIFY to all subscribers. The application in the terminal, when receiving this NOTIFY, checks if an update is needed or not. A terminal that is shut off (no power) will, of course, not receive the NOTIFY, but when it powers on again it will at some point subscribe to the software-update event package. The terminal then immediately receives, as discussed above, the NOTIFY that includes the current version(s) and compares that with the installed version. In this way, the terminal does not lose any information.

A user can unsubscribe if the user is happy with the user's version of the software and does not want any updates. Even if the user subscribes, subscribing does not mean that the user must download or retrieve the available software, because the user can preserve the option of declining if the price is too high, or for other reasons.

It is to be understood that all of the present Figures, and the accompanying narrative discussions of the best mode embodiment, do not purport to be completely rigorous treatments of the method and system under consideration. A person skilled in the art will understand that the steps and signals of the present application represent general cause-and-effect relationships that do not exclude intermediate interactions of various types, and will further understand that the various steps and structures described in this application can be implemented by a variety of different combinations of hardware and software which need not be further detailed herein.

1. A method of finding out about and downloading software updates, comprising the steps of:
sending a subscribe request for software updates regarding an application of a user terminal,
receiving an initial notify message having content defined by an event package, the initial notify message describing at least one available software version,
checking if the user terminal has the available software version, and if not then automatically downloading an update to obtain the available software version, or giving the user a choice whether to download and obtain the available software version,
receiving a further type of notify message having content defined by the event package, the further type of notify message describing at least one newly available update, and
downloading the newly available update unless the user gets and exercises an option to not receive the newly available update,
wherein the at least one available software version was available to subscribers prior to the standardized subscribe request, but the newly available update is newly available to subscribers when the further type of notify message is received.

2. The method of claim 1, wherein the method utilizes and is formatted based upon an application layer protocol known as Session Initiation Protocol, and
wherein the event package requires at least one set of information as to software name, update server address, update retrieval protocol, and latest version.

3. The method of claim 1, wherein the further type of notify message is sent substantially simultaneously to the user terminal and to other user terminals, but
wherein the initial notify message is sent only to the user terminal and is sent to the user terminal substantially immediately after the standardized subscribe request is received and acknowledged.

4. The method of claim 1, wherein the steps encompass, or are also performed for, at least one other application of the user terminal.

5. The method of claim 1, wherein the subscribe request is sent to a centralized software server in the network.

6. The method of claim 1, wherein the subscribe request is sent to a respective server of a software provider.

7. The method of claim 2, wherein the information further includes an update price and a latest update date.

8. The method of claim 1, wherein the sending step and the receiving step are each followed substantially immediately by transmitting an okay response.

9. A computer-readable medium or media for use in a user terminal, the medium being encoded with a data structure for performing the method of claim 1.

10. A system for finding out about and downloading software updates, comprising:
a first user terminal, for sending a standardized subscribe request signal indicative of at least one application in the first user terminal, and
a software server, responsive to the standardized subscribe request signal, for providing an initial notify signal having content defined by an event package, the initial notify signal being indicative of at least one available software version,
wherein the first user terminal is also for downloading an update to obtain the at least one available software version if the first terminal lacks the at least one available software version, provided that a user of the first terminal approved the downloading or has approved automatic downloading,
wherein the system further comprises other user terminals that have at least one application in common with the first terminal,
wherein the first user terminal and the other user terminals are responsive to a further type of notify signal having content defined by the event package, the further type of notify signal being indicative of at least one newly available update to the at least one application in common, and
wherein the first user terminal and the other user terminals are for downloading the at least one newly available update insofar as respective users approve the downloading, or insofar as the respective users have approved automatic downloading.

11. The system of claim 10, wherein the at least one application includes applications from at least two software providers.

12. The system of claim 10, wherein the event package requires at least one set of information as to software name, update server address, update retrieval protocol, and latest version.

13. The system of claim 10, wherein the software server is a centralized software server.

14. The system of claim 10, wherein the software server is a software provider server.

15. The system of claim 10, wherein the standardized subscribe request signal and the notify signal utilize, or are formatted consistently with, and event package based upon an application layer protocol known as Session Initiation Protocol.

16. A subscriber user terminal for finding out about and downloading software updates, comprising:
a plurality of application modules for providing a respective application profile including a respective software version; and
a software update module, for subscribing to at least one server in order to receive software update notifications regarding the plurality of application modules,
wherein the software update module is also for responding to each of the notifications, by requesting at least one of the respective application profiles from the application modules, performing a comparison with a respective one of the notifications, and initiating a download procedure if the comparison indicates a mismatch.

17. The subscriber user terminal of claim 16, wherein the software update module is for finding out about and downloading software updates consistently with an event package that is based upon an application layer protocol known as Session Initiation Protocol.
